(19) United States
(12) Patent Application Publication
(10) Pub. No.: US 2024/0329489 A1
(43) Pub. Date: Oct. 3, 2024

(54) MACH-ZEHNDER INTERFEROMETER WITH IMPROVED MODULATION EFFICIENCY AND LINEARITY

(71) Applicant: HEWLETT PACKARD ENTERPRISE DEVELOPMENT LP, Spring, TX (US)

(72) Inventors: Yiwei Peng, Milpitas, CA (US); Wayne Sorin, Mountain View, CA (US); Yuan Yuan, Milpitas, CA (US); Stanley Cheung, Milpitas, CA (US); Thomas Van Vaerenbergh, Diegem (BE); Marco Fiorentino, Mountain View, CA (US)

(21) Appl. No.: 18/192,509

(22) Filed: Mar. 29, 2023

(51) Int. Cl. G02F 1/21; G02F 1/225; G06N 3/04

(52) U.S. Cl. CPC G02F 1/212; G02F 1/225; G06N 3/04; G02F 2203/50

(57) ABSTRACT

An example Mach-Zehnder interferometer (MZI) is provided. The MZI includes a first waveguide arm and a second waveguide arm coupled to the first waveguide arm via a pair of optical couplers. In the proposed MZI, at least one of the first waveguide arm and the second waveguide arm includes a plurality of Bragg-grating segments and a phase-shifter segment formed between adjacent Bragg-grating segments of the plurality of Bragg-grating segments. The phase-shifter segment formed between adjacent Bragg-grating segments induces a predefined phase-shift in an optical signal propagating through respective at least one of the first waveguide arm and the second waveguide arm, resulting in increased linearity an optical transmission via the MZI.

### BACKGROUND

Optical neural networks include an input section having input cells, a nonlinear activation function, and a scalar weight bank connecting the input section to the nonlinear activation function. Optical devices such as Mach-Zehnder interferometers (MZIs) are widely used as basic building blocks in optical neural networks, especially, in the input section and the scalar weight bank of the optical neural networks. The optical neural networks often require these cells to be tuned frequently during the training process of the optical neural networks by setting weights for respective MZIs. As for the input layer, the performance of silicon photonic modulators is impaired by the lack of a significant electro-optic effect. Generally, the MZIs exhibit sinusoidal transfer function which results in non-linear optical output. Such nonlinear optical output may not be ideal for matrix weighing requiring complex circuitry and training logic.

### BRIEF DESCRIPTION OF THE DRAWINGS

Various examples will be described below with references to the following figures.

FIG. 1A depicts a top view of an example Mach-Zehnder interferometer (MZI) having Bragg-grating and phase-shifter segments.

FIG. 1B depicts a cross-sectional view of the MZI of FIG. 1 along a portion of one of its waveguide arms in a lateral direction.

FIG. 1C depicts a cross-sectional view of the MZI of FIG. 1 at a first location on a waveguide arm of the MZI in a vertical direction.

FIG. 1D depicts a cross-sectional view of the MZI of FIG. 1 at a second location on a waveguide arm of the MZI in the vertical direction.

FIG. 2A depicts a graphical representation illustrating calculated spectral response for an example MZI.

FIG. 2B depicts a graphical representation illustrating a phase response over angular frequencies for an example MZI.

FIG. 2C depicts a graphical representation illustrating group index variations for an example MZI.

FIG. 2D depicts a graphical representation illustrating group index variations over a smaller range of angular frequencies compared to FIG. 2C.

FIG. 3A depicts a graphical representation illustrating simulated effective index change for an example MZI.

FIG. 3B depicts a graphical representation illustrating an overall phase response for several applied voltages for an example MZI.

FIGS. 4A and 4B depict graphical representations illustrating a normalized transmission of an example MZI.

FIG. 4C depicts a graphical representation illustrating a normalized transmission of a conventional MZI.

FIG. 4D depicts a graphical representation illustrating an improvement in the bit-precision of an example MZI compared to a conventional MZI.

FIG. 5 depicts a block diagram of an example photonic integrated circuit.

FIG. 6 depicts a block diagram of an example optical system.

It is emphasized that, in the drawings, various features are not drawn to scale. In fact, in the drawings, the dimensions of the various features have been arbitrarily increased or reduced for clarity of discussion.

### DETAILED DESCRIPTION

The following detailed description refers to the accompanying drawings. Wherever possible, the same reference numbers are used in the drawings and the following description to refer to the same or similar parts. It is to be expressly understood that the drawings are for the purpose of illustration and description only. While several examples are described in this document, modifications, adaptations, and other implementations are possible. Accordingly, the following detailed description does not limit disclosed examples. Instead, the proper scope of the disclosed examples may be defined by the appended claims.

Neuromorphic computing has shown significantly superior performance compared with traditional central processing units (CPUs) for specific neural network tasks. Artificial neural networks implementing neuromorphic computing have proven remarkable capabilities in various tasks, including computer vision, speech recognition, machine translations, medical diagnoses, and gaming. A majority of the electrical artificial neural network hardware's energy consumption comes from data movement in the synaptic interconnections, for example, data movements between memory devices and processors.

Owing to the high bandwidth of modulators and photodetectors, and the low latency of passive waveguides, integrated photonic circuits have shown promising capabilities in deep learning and neural networks compared to electrical equivalents. Optical neural networks, also known as photonic neural networks, are expected to improve energy efficiency and throughput significantly in comparison to electrical artificial neural networks due to their capabilities of transmitting data at the speed of light without having a length-dependent impedance. Optical neural networks include an input section having input cells, a nonlinear activation function, and a scalar weight bank connecting the input section to the nonlinear activation function.

It is useful to build optical neural networks that are efficient and consume low energy. Numerous efforts are underway to lower power consumption on optical neural networks An MZI is a basic photonic device used in the input cells and weight banks in optical neural networks.

As for the input section, a modulation efficiency of an optical device (e.g., an MZI) is a useful measure to quantify modulation performance. Generally, silicon-based MZI modulators have a weak plasma dispersion effect leading to decreased modulation efficiency. Accordingly, conventional silicon-based MZI modulators when used in the input section of the optical neural networks require long phase shifters combined with optical waveguides to achieve a certain amount of phase modulation. These MZI modulators are typically characterized by a larger footprint, low efficiency, and high-power consumption.

Additionally, for use in the weight banks of optical neural networks, higher weighting precision is useful to account for noisy input signals. The photonic systems nowadays are limited to low precision due to the inherent non-linear transfer functions. In particular, the conventional MZIs exhibit a sinusoidal transfer function resulting in a nonlinear optical output. Optical devices such as the MZIs implemented in the weight banks of the optical neural networks are often tuned several times (e.g., several hundreds of times) during the training process of the optical neural network. This tuning entails encoding the output of these optical devices. Due to the sinusoidal (i.e., nonlinear) transfer function of the MZI, the optical neural networks require additional electronic control circuits such as a digital-to-analog converter to compensate for the nonlinearity of the sinusoidal output. In particular, in some implementations, a feedback circuit or a pre-calibrated look-up table may be used for each MZI in the optical neural network to aid in such encoding, which will significantly increase the system complexity, latency, and energy cost. Moreover, since electronic control circuits do not have extremely high precision, the outputs of the traditional MZIs may end up limiting the bit precision of each cell of the optical neural network and further restricting the training correctness of the entire optical neural network. Therefore, the sinusoidal transmission via the traditional MZIs may not be ideal for matrix weighing of the optical neural network as it requires complex circuitry and training logic.

In accordance with the examples presented herein, an enhanced MZI is presented that may overcome one or more of the challenges described hereinabove. In particular, the proposed MZI structure exhibits increased linearity thereby allowing precise control of weights when implemented in optical neural networks. Further, the proposed MZI structure also achieves enhanced modulation efficiency and is also more energy-efficient compared to conventional silicon-based MZIs. Such linearity and modulation efficiency of the proposed MZI may allow it to be used in one or both of the input section and the weight bank in optical neural networks.

In examples consistent with the present disclosure, the proposed MZI includes a couple of waveguide arms (e.g., bus waveguides) coupled to each other via a pair of optical couplers. One or both of the waveguide arms may include a plurality of Bragg-grating segments and a phase-shifter segment formed between adjacent Bragg-grating segments. The phase-shifter segment may induce a predefined phase-shift in an optical signal propagating through respective at least one of the first waveguide arm and the second waveguide arm.

The enhanced modulation efficiency and an energy-efficient operation may be achieved at least in part due to a specially structured optical waveguide having the Bragg-grating segments. The Bragg-grating segments having a periodic corrugation (e.g., parallel ridges and grooves) cause an optical mode of an optical signal passing through the respective waveguide arm to overlap substantially evenly around a central region of the waveguide arm resulting in an enhanced modulation efficiency for the MZI. Owing to enhanced light-matter interaction in a slow-light region formed by the Bragg-grating segments, an increased modulation efficiency is observed. In some examples, slow light refers to the propagation of an optical pulse or other modulation of an optical carrier at a relatively low group velocity. In particular, the proposed MZI exhibits a steeper phase response compared to conventional MZI (e.g., an MZI without Bragg-grating in the waveguide arms). In particular, the proposed MZI may attain up to 6 times higher modulation efficiency compared to the conventional MZI (i.e., requiring up to 6 times smaller voltage magnitude to achieve a unit phase shift compared to the conventional MZI). The power consumption for a modulator is related to the square of the applied voltage. With the proposed novel structure of the MZI, the power consumption can be 6² times lower compared to conventional MZIs, causing optical transmitters using the proposed MZI to become ultra-energy-efficient. For use in optical neural networks, the proposed MZI may lower the training power consumption and lower the bias voltage source requirement at a static state.

Further, the formation of the phase-shifter segment between adjacent Bragg-grating segments induces additional phase shifts (e.g., a predefined phase-shift of TT) which aids in reducing non-linearity in the optical output of the MZI. In particular, by suitably selecting the count of the Bragg-grating segments, the linearity of the optical output may be tuned. To quantify the linearity, a linear regression of the transmission from “0” (e.g., no optical output) to “1” (e.g., full optical output) has been performed, which resulted in the standard error (SE) for the proposed MZI to be about 0.02 (compared to the SE of about 0.0429 for the conventional MZI) which is more than 2 times lower compared to the SE of conventional MZI, resulting in a bit-precision improvement of 1 bit. The higher bit precision in photonics may remove the need for the electronic control circuit, increase system energy efficiency, and lower system latency. Such a linear optical output may avoid the need for a lookup table making the training of optical neural networks faster and easier. Further, compared to the conventional MZIs the proposed MZI structure has a smaller capacitance, resulting in faster switching behavior and reduced power consumption. Also, the proposed MZI structure may have a smaller footprint and offer increased information density compared to conventional MZIs. Furthermore, due to its short dimensions (e.g., shorter length compared to conventional MZIs), the proposed MZI can be operated with lumped electrodes, even at high speed.

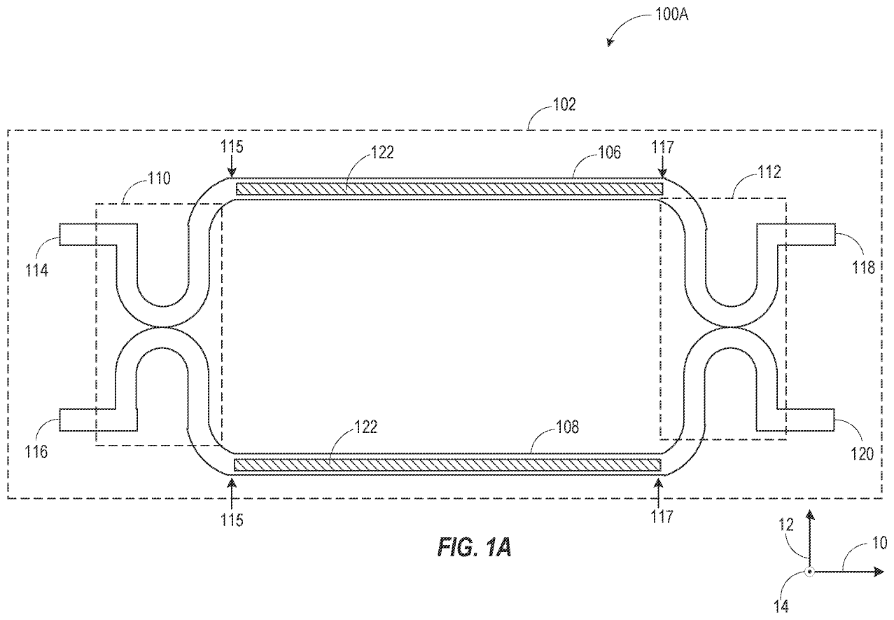

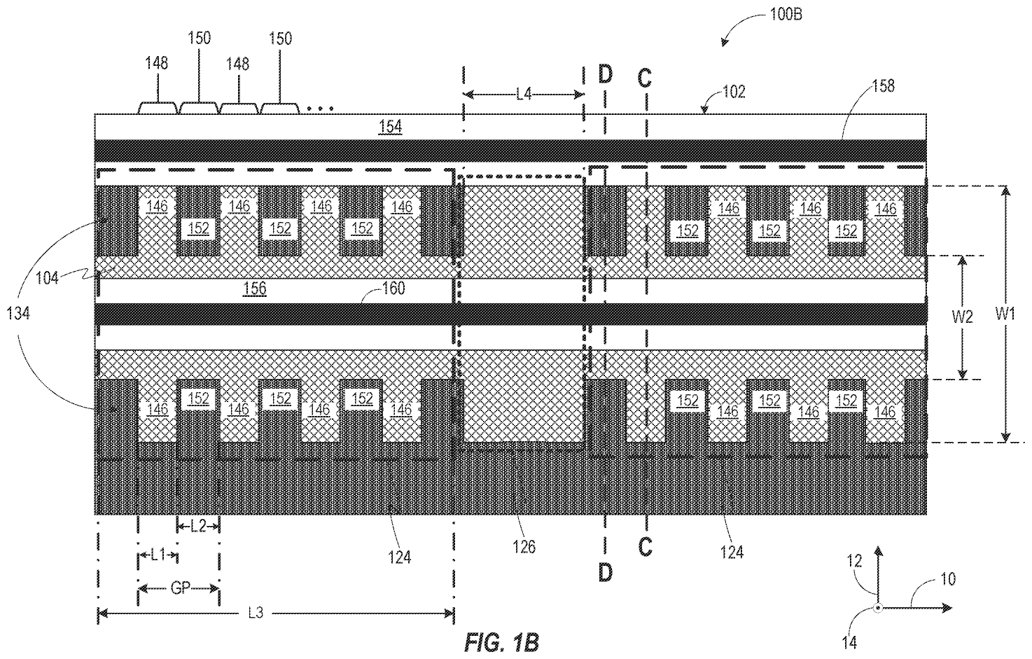

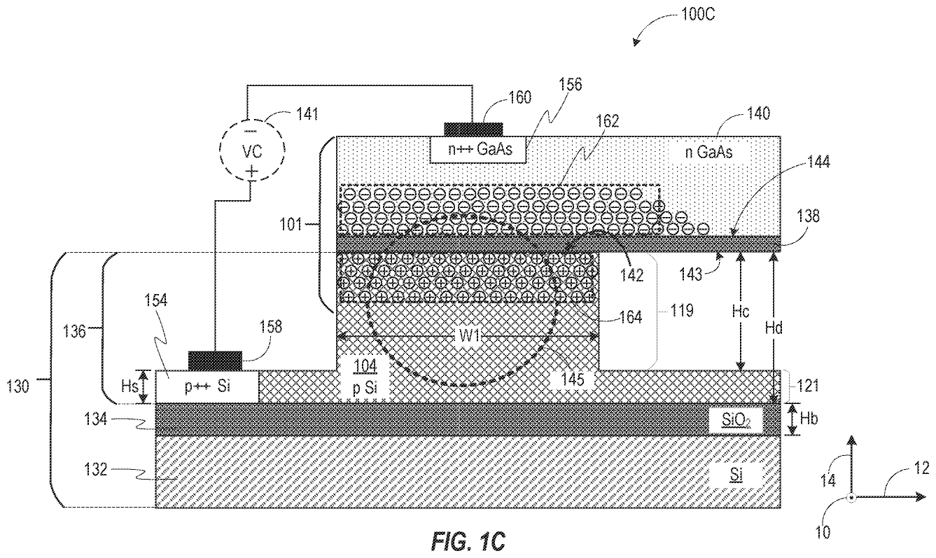

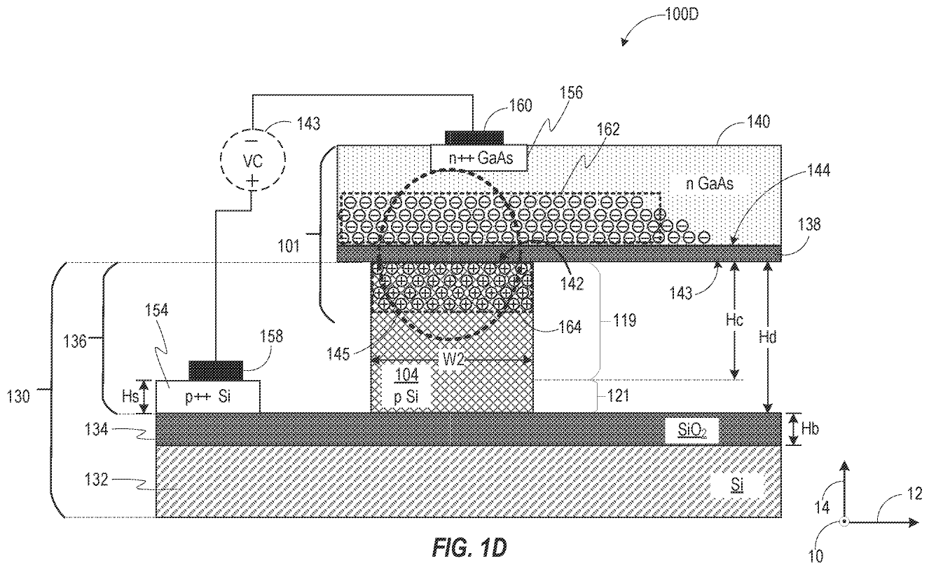

Referring now to the drawings, in FIG. 1A, a top view 100A of an MZI 102 is depicted. The proposed MZI 102 may find applications in optical neural networks capable of storing and processing data in optical form, or in any optical communication system. One or more such MZIs may be implemented in optical neural networks and/or in photonic integrated circuits for any other applications. In one example, such a photonic integrated circuit may be implemented in computers (stationary or portable), servers, storage systems, wireless access points, network switches, routers, docking stations, printers, or scanners.

For the purpose of illustration hereinafter, FIGS. 1A, 1B, 1C, and 1D are described concurrently. In particular, FIG. 1B depicts a cross-sectional view 100B of the MZI 102 taken along a portion of a first waveguide arm 106 in an axial direction 10. FIG. 1C depicts a cross-sectional view 100C of the MZI 102 taken at a first location (marked as a section line C-C in FIG. 1B) in a vertical direction 14. Further, FIG. 1D depicts a cross-sectional view 100D of the MZI 102 taken at a second location (marked as a section line D-D in FIG. 1B) in the vertical direction 14. The cross-sectional views 100C and 100D may be realized when seen in the axial direction 10. Further, in FIGS. 1A-1D, an arrow 12 represents a lateral direction. The axial direction 10, the lateral direction 12, and the vertical direction 14 may be perpendicular to each other. Also, for clarity of representation, certain regions/layers of the MZI 102 shown in the cross-sectional views 100B, 100C, and 100D are not depicted in the top view 100A, or vice-versa.

The MZI 102 includes a pair of waveguide arms, for example, a first optical waveguide arm 106 and a second optical waveguide arm 108; and a pair of optical couplers 110 and 112. In particular, the optical coupler 110 is optically coupled to the waveguide arms 106, 108 at first ends 115 of the waveguide arms 106, 108. Similarly, the optical coupler 112 is optically coupled to the waveguide arms 106, 108 at first ends 117 of the waveguide arms 106, 108. The optical couplers 110 and 112 may be operated as input coupler and output coupler, respectively. Accordingly, the optical couplers 110 and 112 are hereinafter also referred to as an input coupler 110 and an output coupler 112, respectively. Each of the waveguide arms 106, 108 and the optical couplers 110, 112 comprise an optical waveguide to allow propagation of the optical signals (e.g., light) therethrough during the operation of the MZI 102. In an example configuration of the MZI 102, the optical couplers 110 and 112 may be 50%-50% directional couplers.

The input coupler 110 may have input ports 114 and 116, and the output coupler 112 may have output ports 118 and 120. An optical signal may be supplied to any of the input ports 114 and 116, and an optical output of the MZI 102 may be obtained from any of the output ports 118 and 120. For example, during operation, an optical signal may be applied to the input port 114 of the MZI 102. The input optical signal may be divided into two light streams via the input coupler 110 and distributed into the two waveguide arms 106 and 108. The optical signals from both the waveguide arms 106 and 108 of the MZI 102 may be recombined and again divided into two optical output streams that exit via output ports 118 and 120.

In order to improve the modulation efficiency and linearity, the MZI 102 may include a grating structure 122 in one or both the waveguide arms 106 and 108. For illustration purposes, in FIG. 1A, the MZI 102 is shown to have the grating structure 122 in both the waveguide arms 106 and 108. The grating structure 122 may collectively represent Bragg-grating segments 124 and phase-shifter segments 126 formed along the waveguide arms 106 and 108. As depicted in FIG. 1B, the grating structure 122 may be formed along the length of the waveguide arms 106, 108 of the MZI 102. The grating structure 122 may include a plurality of Bragg-grating segments 124 and a phase-shifter segment 126 formed between each adjacent Bragg-grating segment 124. For illustration purposes, in FIG. 1B, a portion of the waveguide arm 106 is depicted with two Bragg-grating segments 124 and a single phase-shifter segment 126 formed between the two Bragg-grating segments 124. The formation of the phase-shifter segment 126 between adjacent Bragg-grating segments 124 induces additional phase shifts (e.g., a predefined phase-shift of TT) which aids in reducing non-linearity in the optical output of the MZI 102.

In an example configuration, the MZI 102 is designed to have waveguide arms of length 74.2 μm having nine (9) Bragg-grating segments 124 and eight (8) phase-shifter segments 126. Each Bragg-grating segment 124 is designed to have a length of 660 nm, and each phase-shifter segment 126 is designed to have a length of 320 nm. In particular, by suitably selecting the count of the Bragg-grating segments 124, the linearity of the optical output of the MZI 102 may be tuned.

The grating structure 122 is described in greater detail in conjunction with the cross-sectional diagrams depicted in FIGS. 1C and 1D. As shown in FIGS. 1C and 1D, the waveguide arm 106 comprising the grating structure 122 may be formed in a common semiconductor substrate 130. In some examples, the semiconductor substrate 130 may be a silicon-on-insulator (SOI) substrate that may include a base substrate layer 132, a base oxide layer 134, and a device layer 136. The base substrate layer 132 may be made of semiconductor material, for example, silicon (Si). Other examples of materials that may be used to form the base substrate layer 132 may include III-V semiconductors, such as indium phosphide (InP), germanium (Ge), gallium arsenide (GaAs), aluminum gallium arsenide (AlGaAs), indium gallium arsenide (InGaAs), indium arsenide (InAs), or combinations thereof. Further, the base oxide layer 134 may be formed by oxidizing the base substrate layer 132 or by way of depositing a dielectric material over the substrate layer 132. In some examples, the base oxide layer 134 may be a buried oxide (BOX) layer (e.g., Silicon dioxide (SiO₂) may be buried in the base substrate layer 132). Example materials of the base oxide layer 134 may include dielectric materials such as, but are not limited to, SiO₂, Silicon Nitride (Si₃N₄), Aluminum oxide (Al₂O₃), Hafnium Dioxide (HfO₂), diamond, silicon carbide (SiC), or combinations thereof. In some examples, a layer of SiO₂ may be buried in the base substrate layer 132 at a depth ranging from less than 100 nm to several micrometers from the wafer surface depending on the application. In some other examples, the base oxide layer 134 (e.g., BOX) of about 2 μm thickness/height (Hb) may be formed on the base substrate layer 132 (e.g., made of Si).

The device layer 136 may be formed on top of the base oxide layer 134. In the example implementation of FIG. 1, the device layer 136 is composed of silicon. In one example, the device layer 136 may have a thickness/height (Hd) of about 300 nm on the base oxide layer 134 (e.g., BOX). The device layer 136 may be suitably shaped (e.g., via techniques such as photolithography and etching) to form one or more regions, such as, an optical waveguide 104 and contact regions (described later), for example. Further, in some examples, the device layer 136 may be doped with impurities in a region that is defined as the optical waveguide 104 to introduce free charge carriers in the optical waveguide 104. In some examples, the optical waveguide 104 is made of semiconductor material of the device layer (e.g., InP, Ge, GaAs, AlGaAs, InGaAs, InAs, or combinations thereof).

In some examples, the waveguide arm 106 may include a waveguide-integrated capacitor 101 formed via the optical waveguide 104, an insulating layer 138, and an electrically conductive layer 140. For the clarity of representation of the features of the optical waveguide 104, the insulating layer 138 and the electrically conductive layer 140 are not shown in the top view 100B of FIG. 1B but, are shown in the cross-sectional views 100C and 100D depicted respectively in FIGS. 1C and 1D. As depicted in FIGS. 1C and 1D, the insulating layer 138 is formed on a first side 142 of the optical waveguide 104. Further, the electrically conductive layer 140 is formed over the insulating layer 138. In particular, the electrically conductive layer 140 may be formed on a second side 144 of the insulating layer 138. The second side 144 of the insulating layer is opposite a first side 143 of the insulating layer 138. In particular, the waveguide-integrated capacitor 101 is formed such that the insulating layer 138 is sandwiched between the optical waveguide 104 and the electrically conductive layer 140.

As shown in FIGS. 1C and 1D, the electrically conductive layer 140 may be formed using a doped III-V semiconductor material. In some other implementations, the use of other types of electrically conductive materials is also envisioned within the purview of the present disclosure to form the electrically conductive layer 140. In some examples, to form the electrically conductive layer 140, a layer of III-V semiconductor material may be heterogeneously formed on the second side 144 (e.g., on top of) the insulating layer 138. The electrically conductive layer 140 may be formed using epitaxial growth, deposition techniques (e.g., CVD), wafer bonding, transfer printing, or combinations thereof. In particular, techniques such as epitaxial growth and/or wafer bonding of the electrically conductive layer 140 facilitate planar heterogeneous integration of other device structures such as lasers, modulators, and photon detectors all on a common substrate (e.g., the substrate 130). In an example configuration, the electrically conductive layer 140 and the insulating layer 138 may be designed to have heights of 190 nm and 15 nm, respectively.

In some examples, the electrically conductive layer 140 may be chosen to have a lower refractive index as compared to the optical waveguide 104. In some examples, the electrically conductive layer 140 may also be chosen to have a higher refractive index as compared to the optical waveguide 104.

The optical waveguide 104 may include a first-type doping and the III-V semiconductor material in the electrically conductive layer 140 may include different second-type doping. For illustration purposes, the first-type doping is described as p-type and the second-type doping is described as n-type. In other examples, the first-type doping may be n-type and the second-type doping may be p-type. In the description hereinafter and in the drawings, the optical waveguide 104 and the electrically conductive layer 140 are shown to include p-type (i.e., the first-type doping) doping and n-type doping (i.e., the second-type doping), respectively. In the description hereinafter, the term “free charge carriers” or “free carriers” may represent the free electrons with reference to the semiconductor material when having n-type doping. Further, the term “free charge carriers” or “free carriers” may represent the free holes with reference to the semiconductor material when having p-type doping. In an example configuration, the optical waveguide 104 may be uniformly p-doped with a boron concentration of 2×10¹⁸ cm⁻³, and the contact regions (described later) may be heavily doped compared to the rest of the device layer 136. Further, the electrically conductive layer 140 may be n-type doped at a concentration of 3×10¹⁸ cm⁻³ and wafer bonded to the device layer 136.

In accordance with examples consistent with the present disclosure, the optical waveguide 104 (and so the waveguide-integrated capacitor 101) may be designed to have Bragg-grating segments 124 and phase-shifter segments 126. For illustration purposes, in FIG. 1B, a portion of the waveguide arm 106 depicting two have Bragg-grating segments 124 separated by a phase-shifting segment 126 is shown. As depicted in FIG. 1B, the Bragg-grating segments 124 may include a plurality of parallel ridges 146 of the semiconductor material formed along the length of the optical waveguide 104. Due to the formation of the ridges 146 in the optical waveguide 104, the optical waveguide 104, in the Bragg-grating segment 124, includes alternately formed first sections 148 and second sections 150 (see FIG. 1B). In particular, the cross-sectional view 100C represents a cross-section of the waveguide arm 106 taken along a first section 148, and the cross-sectional view 100D represents a cross-section of the waveguide arm 106 taken along a second section 150 or the phase-shifter segment 126. The first sections 148 define the ridges 146, and the second sections 150 define grooves 152.

The optical waveguide 104 may be formed to have a first width W1 (see FIG. 1C) along the first sections 148 and the phase-shifting segment 126, and a second width W2 (see FIG. 1D) along the second sections 150, where W2 is smaller than W1. In certain other examples, the optical waveguide 104 may be designed to have a different third width W3 (not shown in FIGS. 1A-1D) in the phase-shifting segment 126. In particular, to form the grooves 152 in the second sections 150, the material of the device layer 136 may be removed (e.g., by chemically or mechanically etching the material of the device layer 136 from the second sections 150) except in the width W2 (see FIG. 1D). For example, as depicted in the cross-section view 100D of FIG. 1D, the material of the device layer 136 does not exist on the base oxide layer 134 except along the width W2. By removing the material of the device layer 136 in the second sections 150 as described, the ridges 146 are formed in the device layer 136 in the first sections 148.

Further, due to the absence of the material of the device layer 136 (except along the width W2), the optical waveguide 104, in the second sections 150, is narrower than in the first sections 148. In some examples, the width W1 may be set to 500 nm, the width W2 may be set to 300 nm, a height/thickness (Hc) of a core region 119 of the optical waveguide 104 may be set to 225 nm, and a height (Hs) of a waveguide base 121 (also referred to as slab height Hs) may be set to 75 nm. Accordingly, in an example implementation, the total height (Hd=Hc+Hs) of the device layer 136 is 300 nm. Further, the height (Hb) of the base oxide layer 134 may be set to about 2 μm on the base substrate layer 132).

Also, for illustration purposes, in FIG. 1B, the ridges 146 are shown as uniformly distributed along the Bragg-grating segment 124. In particular, to have the uniform distribution of the ridges 146 along the length of the optical waveguide 104, the spacing between adjacent ridges 146 is maintained uniformly. In an example implementation of the MZI 102, a length L1 of the first sections 148 may be set to 330 nm, and a length L2 of the second sections 150 (e.g., a distance between two adjacent ridges 146) may be set to 330 nm. In some other examples, the optical waveguide 104 may be designed to have non-uniformly distributed ridges, without limiting the scope of the present disclosure. A sum of the lengths L1 and L2 represent a grating period (GP). The total length L3 may be equal to (GP)×C, where C=count of ridges in a single Bragg-grating segment 124. Accordingly, in the example implementation of the MZI 102 with four grating units (e.g., comprising a ridge 146 and a groove 152) each having a grating period of 660 nm, the total length L3 of the Bragg-grating segment 124 may be 2640 nm.

Further, in some examples, the phase-shifting segment 126 may be formed to have a length L4. The length L4 may be chosen to be higher than that of the sections 148, 150 (i.e., L4>L1, L2). In certain examples, the phase-shifter segment 126 is designed with the length L4 to induce a predefined phase-shift of IT.

Furthermore, in some examples, the MZI 102 may include contact regions 154 and 156 (hereinafter collectively referred to as contact regions 154-156). The contact region 154 is formed in the device layer 136 in electrical contact (e.g., in direct physical contact or via any intermediate electrically conductive material) with the optical waveguide 104 in the first sections 148 (see FIGS. 1C and 1D). Accordingly, the contact region 154 may comprise the material of the device layer 136. The optical waveguide 104 may not be in direct contact with the contact region 154 in the second sections 150. Further, the contact region 156 is formed in the electrically conductive layer 140 and includes a material of the electrically conductive layer 140. In some examples, the contact regions 154 and 156 may respectively include the first-type doping and the second-type doping. In some examples, for good electrical conductivity, the contact regions 154 and 156 may have a higher concentration of respective doping in comparison to doping concentrations in the optical waveguide 104 and the electrically conductive layer 140. Accordingly, the contact regions 154, 156 may be considered highly doped regions and are marked with labels “p++” and “n++”.

Moreover, in some examples, the MZI 102 may include metal contacts 158 and 160 (hereinafter collectively referred to as metal contacts 158, 160). As depicted in FIGS. 1C-1D, the metal contacts 158, 160 are respectively formed in electrical contact (e.g., in direct physical contact or via any intermediate electrically conductive material) with the contact regions 154, 156. In some examples, the metal contacts 158, 160 may be formed on top of (i.e., vertically over) the contact regions 154, 156, respectively. Examples of materials used to form the metal contacts 158, 160 may include, but are not limited to, copper (Cu), gold (Au), Al, and/or platinum (Pt).

In accordance with examples consistent with this disclosure, the MZI 102 may be implemented in an input section in an optical neural network, where the MZI 102 may operate at increased modulation efficiency with reduced power consumption compared to conventional MZIs. In particular, during the operation of the MZI 102, an optical signal may be passed through the optical waveguide 104 and the waveguide-integrated capacitor 101 may be operated in a charge carrier accumulation mode. In particular, to operate the waveguide-integrated capacitor 101 in the charge carrier accumulation mode, a forward bias control voltage (Vc) may be applied to the waveguide-integrated capacitor 101 via an external power source 141 (see FIGS. 1C and 1D) through the metal contacts 158, 160. In an example implementation, the control voltage (Vc) is applied such that a positive potential (e.g., higher potential) appears at the metal contact 158 and a negative potential (e.g., higher potential) appears at the metal contact 160. In particular, when the waveguide-integrated capacitor 101 is operated under such control voltage (Vc), the free carriers accumulate on either side of the insulating layer 138 in the electrically conductive layer 140 and in the optical waveguide 104 due to a forward electric field caused by the control voltage (Vc).

On application of the control voltage (Vc), the density of the electrons and holes may increase in regions 162, 164 (marked with dashed lines), respectively, and are therefore referred to as charge carrier-rich regions 162, 164. In particular, the charge carrier-rich regions 162, 164 represent volumes of the electrically conductive layer 140 and in the optical waveguide 104, respectively, in which free charge carriers have higher density compared to the rest of the volume of the electrically conductive layer 140 and in the optical waveguide 104 on the application of the control voltage (Vc). The densities of electrons and holes, respectively, in the charge carrier-rich regions 162, 164 increase with an increase in the control voltage (Vc) and decreases with a decrease in the control voltage (Vc). The increase in the charge carrier densities in the charge carrier-rich regions 162, 164 reduces the refractive index of the waveguide-integrated capacitor 101. On the other hand, the decrease in the charge carrier densities in the charge carrier-rich regions 162, 164 increases the refractive index of the waveguide-integrated capacitor 101. The phase of the optical signal propagating through the optical waveguide 104 thus varies with the variations in the refractive index. Accordingly, the control voltage (Vc) may be suitably controlled to induce a desired phase shift in the optical signal.

In some examples, the control voltage (Vc) may be modulated by a modulating signal (not shown). In particular, when the control voltage (Vc) is modulated, the refractive index and hence, the phase of the optical signal, within the waveguide-integrated capacitor 101 may vary in accordance with the modulating signal. This results in a modulation of the optical signal passing through the MZI 102 based on the modulating signal.

Generally, the optical mode (i.e., an electric field distribution of an optical signal) tends to be confined in the high refractive index medium. In the proposed MZI 102, the optical waveguide 104 (e.g., made of Silicon) has a slightly higher refractive index compared to the electrically conductive layer 140 (e.g., made of III-V semiconductor layer). Therefore, the heterogeneous integration of the electrically conductive layer 140 over the optical waveguide 104 causes an optical mode 145 (see FIG. 1C) inside the optical waveguide to overlap with all of the electrically conductive layer 140, the insulating layer 138, and mostly in the optical waveguide 104, within which the charge carrier densities are varied with the application of the control voltage (Vc).

Moreover, the use of the Bragg-grating segments 124 in the optical waveguide 104 enhances the overlap of the optical mode 145 (see FIG. 1D) with the charge carrier-rich regions 162, 164. In particular, the narrow second sections 150 cause the optical mode 145 to change its shape and shift more toward the electrically conductive layer 140. Accordingly, the overall profile of the optical mode 145 along the length of the MZI 102, aligns closely in the middle of the waveguide-integrated capacitor 101. In particular, the formation of the Bragg-grating segment 124 in the optical waveguide 104 causes the optical mode 145 to be distributed substantially equally on either side of the insulating layer 138 (see FIG. 1D). Such an even distribution of the optical mode 145 can cause maximum possible overlap between the charge carrier-rich regions 162, 164 and the optical mode. Accordingly, the variation in the material properties (e.g., refractive index) of the charge carrier-rich regions 162, 164 can cause a maximum impact on the phase of the optical signal passing through the MZI 102, resulting in a great improvement in the modulation efficiency of the MZI 102. Additional benefits offered by the example MZI 102 are described in conjunction with following drawings.

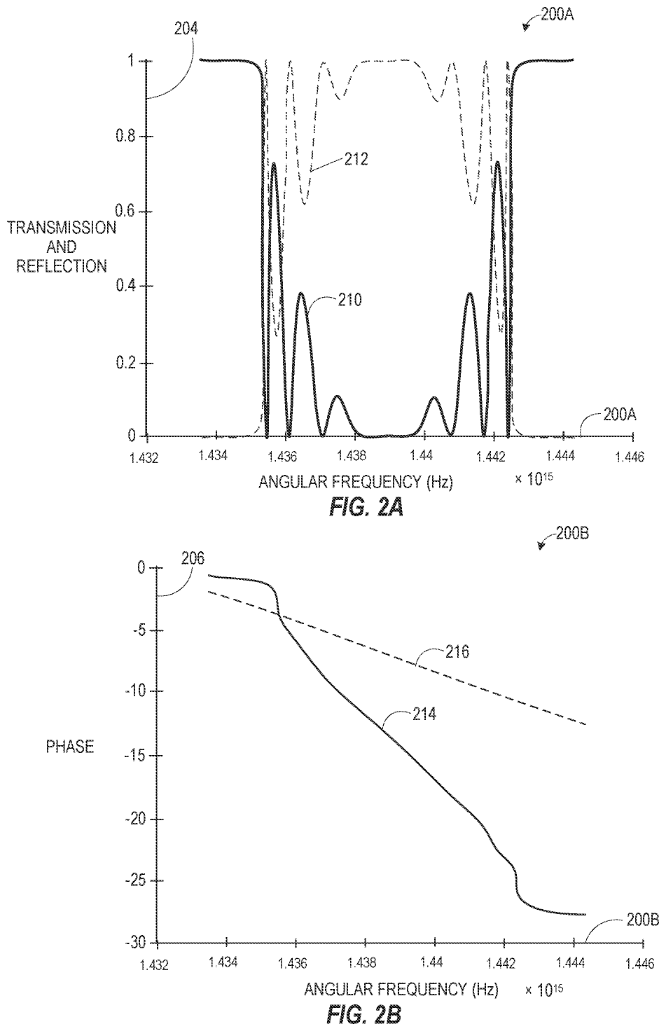

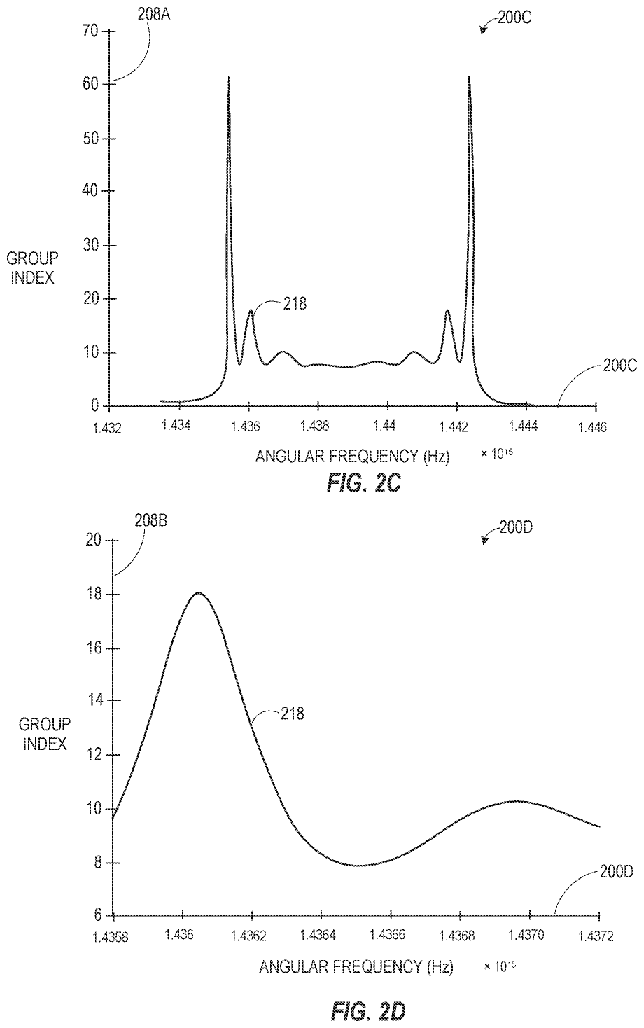

Referring now to FIGS. 2A-2D, several graphical representations are described to demonstrate the enhanced modulation capability offered by the proposed MZI 102. In particular, FIG. 2A depicts a graphical representation 200A of a calculated spectral response for an MZI, for example, the MZI 102. FIG. 2B depicts another graphical representation 200B illustrating phase variations for MZI 102. Further, FIG. 2C depicts another graphical representation 200C illustrating group index variations for the MZI 102. Furthermore, FIG. 2D depicts another graphical representation 200D illustrating group index variations over a smaller range of angular frequencies compared to FIG. 2C.

In the graphical representations 200A-200D, an X-axis 202A, 202B, 202C, and 202D represent angular frequency in Hertz (Hz). In FIGS. 2A, a Y-Axis 204 represents a transmission. Further, in FIGS. 2B, a Y-Axis 206 represents phase values. Furthermore, in FIGS. 2C and 2D, Y-axis 208A and 208B represent Group Index Values.

A transmission (T) through the MZI 102 having the Bragg-grating segments 124 and the phase-shifting segments 126 may be calculated using an example relationship of equation (1).

$$T = {( A P A )}^{M} \qquad Equation ( 1 )$$

Where, A represents a transfer matrix of the Bragg-grating segments 124 on each side of the phase-shifting segments 126, P represents a transfer matrix of propagation through the phase-shifting segment 126, and M represents a count of Bragg-grating segments 124. The transfer matrix A and P may be determined using example relationships of equations (2) and (3), respectively.

$$Equation ( 2 )$$

$$A = [ \begin{matrix}\begin{matrix}cosh ( l \sqrt{{k}^{2} - Δ {β}^{2}} ) + \\ j \frac{Δ β}{\sqrt{{k}^{2} - Δ {β}^{2}}} sinh ( l \sqrt{{k}^{2} - Δ {β}^{2}} )\end{matrix} & j \frac{k}{\sqrt{{k}^{2} - Δ {β}^{2}}} sinh ( l \sqrt{{k}^{2} - Δ {β}^{2}} ) \\ - j \frac{k}{\sqrt{{k}^{2} - {Δβ}^{2}}} sinh ( l \sqrt{{k}^{2} - Δ {β}^{2}} ) & \begin{matrix}cosh ( l \sqrt{{k}^{2} - {Δβ}^{2}} ) - \\ j \frac{Δβ}{\sqrt{{k}^{2} - Δ {β}^{2}}} sinh ( l \sqrt{{k}^{2} - Δ {β}^{2}} )\end{matrix}\end{matrix} ]$$

$$P = [ \begin{matrix}exp ( j β \frac{∧}{2} ) & 0 \\ 0 & exp ( - j β \frac{∧}{2} )\end{matrix} ] \qquad Equation ( 3 )$$

### In Equations (2) and (3),

$$l G P l = \frac{G P}{2} GP = ∧ * Nrepresents a length equal to half of the grating period ( ) ( i . e . , ) ,$$

$$wherein$$

$$lGPl = \frac{G P}{2} G P = ∧ * N ,$$

N represents a count of Bragg-grating units in one Bragg-grating segment 124,
k represents a coupling coefficient to Bragg-grating,
Δβ represents wavenumber detuning (not a constant, changes with wavelength), wherein

$$Δβ = β - \frac{π}{∧} ,$$

β represents a propagation constant that changes with wavelength, and
∧ represents a length of a single Bragg-grating segment 124.

Table 1 represented below provides example values of design parameters used to calculate the transmission using Equations (1)-(3).

TABLE 1
Example values of design parameters for Equations (1)-(3)

| Parameter | Example value |
|---|---|
| M | 9 |
| ∧ | 660 nm |
| N | 12 |
| GP | 7920 |
| l | 3960 |
| k | 2.9 * 105 m⁻¹ |
| β | 1.466e+07 m⁻¹ at 1.436 Pico Hertz (pHz) |
| $Δ β = β - \frac{π}{∧}$ | 2.38e+05 m⁻¹ at 1.436 pHz |

In graphical representation 200A, a curve 210 (shown using a solid line) represents a plot of transmission (T) through the MZI 102 calculated using equation (1) for the wavelengths ranging from 1300 nm to 1320 nm. The operating angular frequency for this case is between 1.436 pHz and 1.437 pHz, where the reflection (e.g., a curve 212—shown using a dashed line) is around 20% and the corresponding insertion loss is around 0.97 dB, which is a small value. The graphical representation 200B depicts how the use of phase-shifting segments 126 aid in improving phase modulation. In graphical representation 200B, a curve 214 (shown using a solid line) represents a phase response of the MZI 102 and a curve 216 (shown using a dashed line) represent a phase response of a conventional MZI (e.g., an MZI without Bragg-grating and phase-shifting segments). The phase response 214 of the MZI 102 is about 3 times steeper compared to the phase response 216 of the conventional MZI. Owing to enhanced light-matter interaction in the slow-light region, an increased modulation efficiency is observed.

The applied voltage to achieve a certain phase difference increases linearly with the group index. A group index curve 218 of the MZI 102 is depicted in the graphical representations 200C and 200D. The group index curve 218 indicates that the group index for the MZI 102 has improved up to between 8 and 18, while the conventional MZI has the group index of about 4. Additionally, as described in conjunction with FIGS. 1A-1D, in addition to the slow light, the modulation efficiency of the MZI 102 also improves due to an increased overlap of the optical mode with the optical waveguide 104 and the electrically conductive layer 140 causing increased optical confinement around the insulating layer 138.

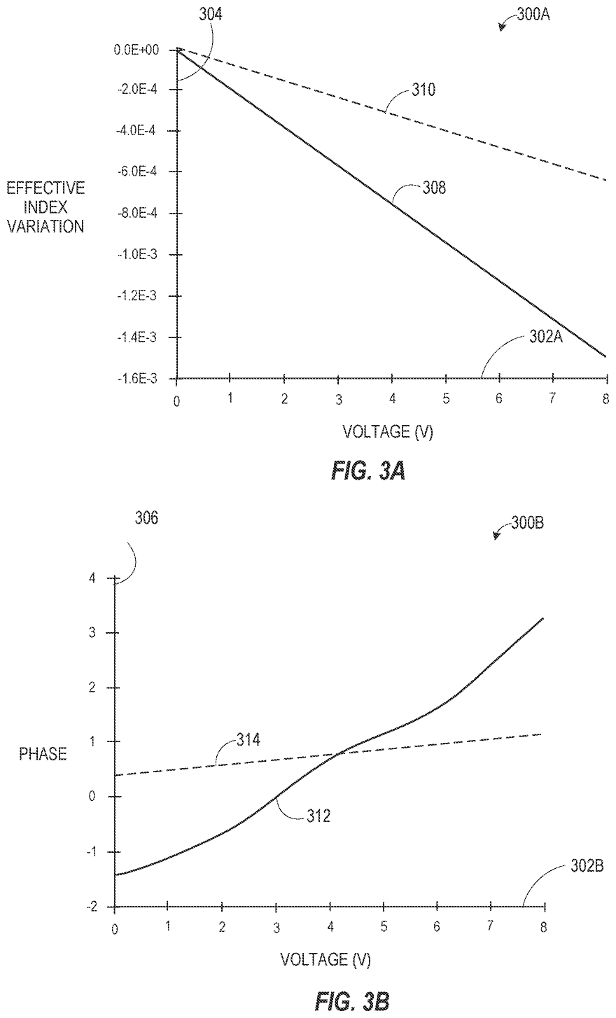

Referring now to FIGS. 3A and 3B, the graphical representations presented in FIGS. 3A and 3B illustrate an energy efficiency of the MZI 102. In particular, FIG. 3A depicts a graphical representation 300A illustrating simulated effective index change for the MZI 102 and a conventional MZI. Further, FIG. 3B depicts a graphical representation 300B illustrating an overall phase response of the MZI 102. In FIGS. 3A and 3B, X-axes 302A and 302B represent applied voltage (Vc) in Volts. A Y-axis 304 of FIG. 3A represents simulated effective index change, and a Y-axis 306 of FIG. 3B represents a phase.

A curve 308 (shown using a solid line) represents an effective index change for a given applied voltage for the MZI 102, and a curve 310 (shown using a dashed line) represents an effective index change for the given applied voltage for the conventional MZI. As depicted in the graphical representation 300A, the curve 308 has a much higher slope compared to the curve 310. The higher slope of the curve 308 indicates that the proposed MZI 102 may achieve larger effective index variations for a given applied voltage compared to the conventional MZI. The modulation efficiency varies with the change in the effective index variations. Larger effective index variations for a given voltage may result in a higher modulation efficiency. In particular, according to a Lumerical simulation, the MZI 102 attains a more than 2 times increase in modulation efficiency compared to the conventional MZI.

Taking into consideration both the optical confinement and slow light effect into consideration, the overall phase variation can be plotted as a curve 312 (shown using a solid line) for the MZI 102. A curve 314 (shown using a dashed line) represents phase variations for the conventional MZI. Compared to the phase variations of the conventional MZI (e.g., the curve 314), the MZI 102 shows a substantially increased slope in the phase response (represented via the curve 312). The higher slope of the curve 312 indicates that the proposed MZI 102 may achieve larger phase variations for a given applied voltage compared to the conventional MZI. In an example implementation, the proposed new MZI 102 may consume about 6 Volts to achieve a phase shift of π (e.g., half of a free spectral range). Accordingly, the corresponding modulation efficiency (VπL) of the MZI 102 may be about 0.045 V·cm, which is improved by 6 times compared to the conventional MZI.

The low-power operation of the proposed MZI 102 may be achieved, at least partially, due to the formation of the waveguide-integrated capacitor 101 as it causes the MZI 102 to consume near-zero static power consumption. The power consumption for a modulator is related to the square of the applied voltage. With the proposed novel structure of the MZI 102, the power consumption can be 6² times lower compared to conventional MZIs, causing optical transmitters using the proposed MZI to become ultra-energy-efficient. For use in optical neural networks, the proposed MZI may lower the training power consumption and lower the bias voltage source requirement at a static state.

Additionally, the formation of the phase-shifter segments 126 between adjacent Bragg-grating segments 124 collectively induces additional phase shift (e.g., a predefined phase-shift of TT) which aids in reducing non-linearity in the optical output of the MZI. In particular, by suitably selecting the count of the Bragg-grating segments 124, the linearity of the optical output may be tuned. The increased linearity causes the MZI 102 to operate at a higher bit precision. Further, the linear optical output of the MZI 102 may avoid the need for a lookup table making the training of optical neural networks faster and easier. Also, compared to the conventional MZIs the proposed MZI structure has a smaller capacitance, resulting in faster switching behavior and reduced power consumption. Furthermore, the proposed MZI 102 with Bragg-grated optical waveguide 104 is suitable for current III-V/Si hybrid photonics platforms and no additional III-V materials and fabrication steps may be required resulting in decreased manufacturing costs and process complexity.

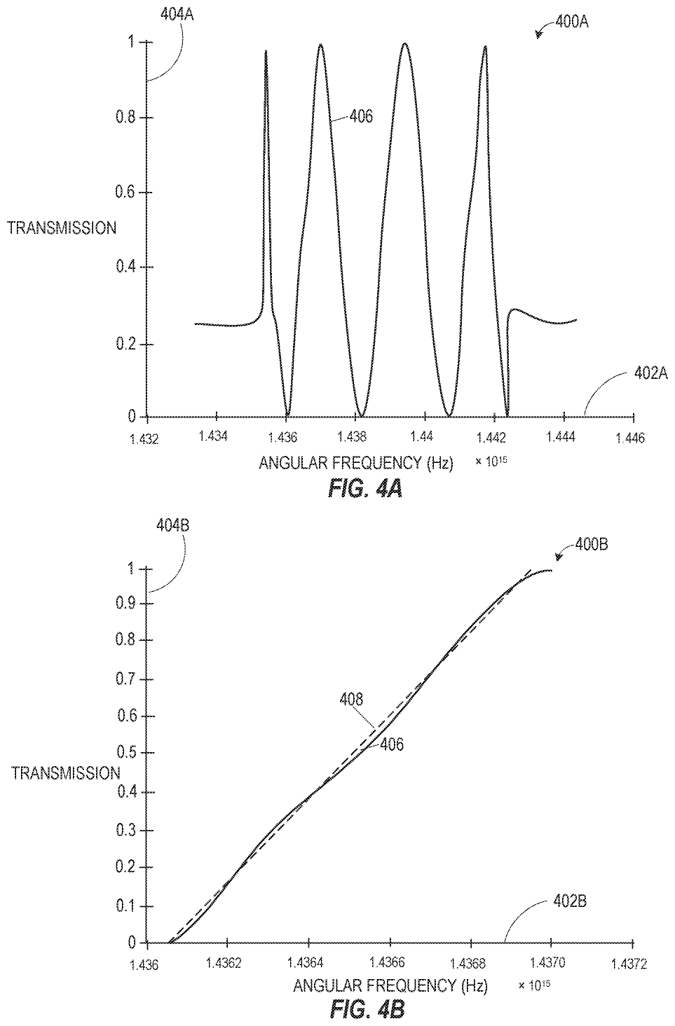

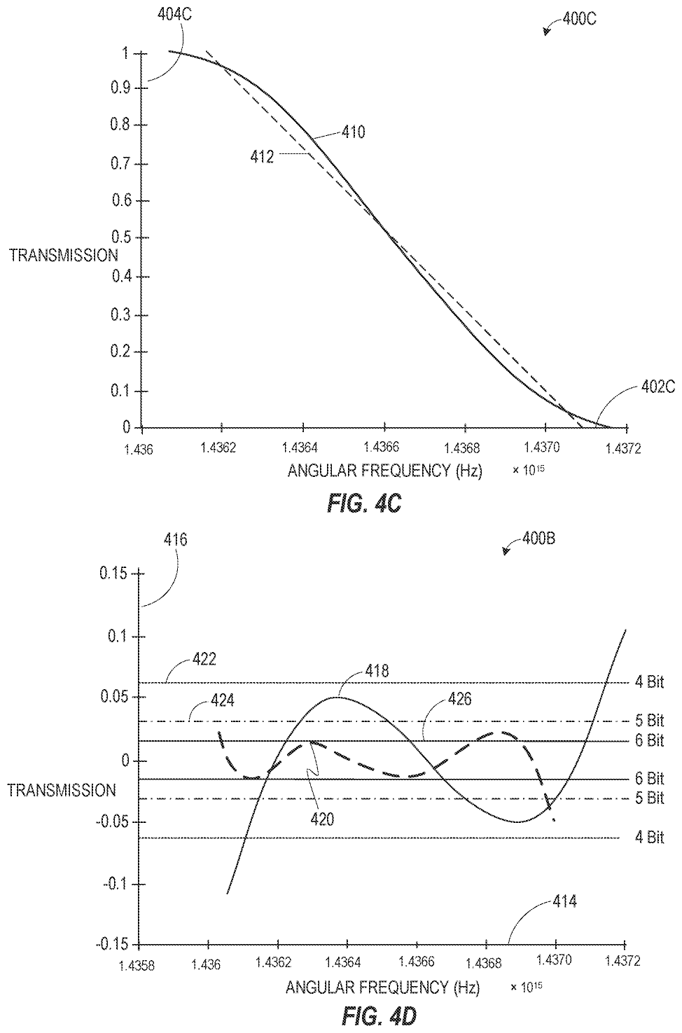

For efficient use in optical neural networks, optical devices with better weighting precision are more suitable. In addition to achieving increased modulation efficiency and being highly energy efficient, the proposed MZI 102 also achieves increased bit-precision compared to the conventional MZIs. FIGS. 4A-4D depicts various graphical representations illustrating linearity and bit-precision offered via the MZI 102. In particular, FIG. 4A depicts graphical representations 400A illustrating a normalized transmission of an example MZI (e.g., the MZI 102 of FIG. 1). Further, FIGS. 4B and 4C respectively depict graphical representations 400B and 400C illustrating a comparison of the normalized transmission of the MZI 102 and a normalized transmission of a conventional MZI with a linear response. FIG. 4D depicts a graphical representation 400D illustrating an improvement in the bit-precision of the MZI 102 compared to the conventional MZI. In particular, in the graphical representations 400A, 400B, and 400C, X-axes 402A, 402B, and 402C represents angular frequencies in Hz, and a Y-axes 404A, 404B, and 404C represent transmission (also called normalized optical power). On the Y-axes 404A, 404B, and 404C, a value of 1 (one) represents maximum transmission and a value of 0 (zero) represents non-detectable or no optical transmission.

Further, for the purpose of illustration, both optical couplers 110 and 112 of the respective MZI 102 are designed to be 50%-50% couplers (i.e., the couplers are designed to transmit half of the input optical power into each of the two waveguide arms of the MZI). By selectively choosing the count of Bragg-grating segments 124 and a count of the gratings (e.g., the count of ridges 146), the transmission via the MZI 102 may be linearized. For a given optical input at one of the input ports of the input coupler 110, an optical output may be calculated using the transfer function of Equation (1). Such calculated transmission is plotted as a curve 406 (shown using a solid line), hereinafter referred to as a normalized optical power or transmission 406 of the MZI 102, in the graphical representation 400A.

The graphical representation 400B of FIG. 4B represents an enlarged portion of a linear region of the transmission 406 in a period (e.g., between the angular frequency of 1.436 Hz and 1.437) and a linear regression is applied to the transmission from 0 to 1. Also, the graphical representation 400B shows a linear fitting curve 408 (shown using a dashed line) for the transmission 406. Similarly, the graphical representation 400C of FIG. 4C shows an example calculated transmission 410 (shown using a solid line) for the conventional MZI in a similar period as that of the transmission 406, and a linear fitting curve 412 (shown using a dashed line) for the transmission 410. The standard error/standard deviation (01) between the transmission 410 of the conventional MZI and the linear fitting curve 412 is about 0.0429. Whereas the standard error/standard deviation (02) between the transmission 406 of the MZI 102 and the linear fitting curve 408 is about 0.02, which is more than 2 times lower compared to the standard deviation (σ1). These values of σ1 and σ2 are indicative of the proposed MZI 102 being capable of exhibiting enhanced linearity compared to the conventional MZI.

Turning now to FIG. 4D, a graphical representation 400D showing a comparison of bit-precision among the conventional MZI and the MZI 102 of FIG. 1 is depicted. In particular, an X-axis 414 represents angular frequencies in Hz and a Y-axis 416 represents transmission residuals of the linear regression. The term “transmission residual” as used herein may refer to a difference between the transmission and respective linear response.

In the graphical representation 400D, a curve 418 (shown using a solid line) depicts the transmission residuals for the conventional MZI which may be representative of a difference between the curves 410 and 412 (see FIG. 4C). Further, a curve 420 (shown using a dashed line) depicts the transmission residuals for the MZI 102 which may be representative of a difference between the curves 306 and 308 (see FIG. 4B). To compare the transmission residuals 418 and 420 with the least significant bit (LSB) values, a 4-bit LSB, 5-bit LSB, and 6-bit LSB lines are superimposed on the graphical representation 300. The 4-bit LSB, 5-bit LSB, and 6-bit LSB lines are respectively marked with reference numerals 422, 424, and 426. From the graphical representation 400D, it is observed that the MZI 102 of FIG. 1 may achieve 6-Bit precision which is 1 bit higher compared to the conventional MZI. Also, the conventional MZI may need to be longer (e.g., having longer waveguide arms compared to the proposed MZI 102) to achieve a similar response at a certain wavelength range, which leads to a larger capacitance impacting its performance.

Referring now to FIG. 5, a block diagram of an example photonic integrated circuit 500 is depicted. The photonic integrated circuit 500 may include a photonics controller 502 and an optical neural network 504. Although not shown in FIG. 5, the photonic integrated circuit 500 may also include other photonic devices such as but not limited to, optical converters, optical cables, waveguides, optical modulators (e.g., ring modulator), optical demodulators (e.g., ring demodulator), resonators, light sources (e.g., lasers), or the like. In an example implementation, the photonic integrated circuit 500 may function as a neuromorphic computing unit capable of storing and/or processing data optically.

The optical neural network 504 may be implemented using techniques such as a coherent optical neural network or a wavelength division multiplexing (WDM) optical neural network, for example. The optical neural network 504 may include an input section 506 (also, commonly referred to as an input cell), a weight bank 508, and a logic circuit 510. The input section 506 may be configured to receive input optical signals (e.g., optical signals representing training/test data and/or field data for which an inference is to be made). The input section 506 may then process (e.g., modulate) the received input optical signals and supply the processed optical signals to the weight bank 508. The weigh bank 508 may apply predetermined weightage to each optical signal received from the input section 506 to generate a weighted optical signal. Several such weighted optical signals may be supplied to the logic circuit 510. In some examples, the logic circuit 510 may be configured to perform a sum of the weighted optical signals and generate an inference by applying a nonlinear activation function thereto.

To perform optical operations, such as modulation, applying weights, etc., one or both of the input section 506 or the weight bank 508 may implement one or more optical devices, for example, the MZI 102. Although a single MZI 102 is depicted in each of the input section 506 or the weight bank 508, the input section 506 and/or the weight bank 508 may use more than one MZIs 102. As previously noted, the MZI 102 exhibits enhanced modulation efficiency and linearity compared to the conventional MZI, resulting in an efficient operation of the optical neural network 504.

Further, The photonics controller 502 may be implemented using an IC chip such as, but not limited to, an ASIC, an FPGA chip, a processor chip (e.g., CPU and/or GPU), a microcontroller, or a special-purpose processor. During the operation of the photonic integrated circuit 500, the photonics controller 502 may apply signals (e.g., voltages Vc) to operate the optical devices (e.g., the MZIs 102) and/or to control the overall functioning of the optical neural network 504.

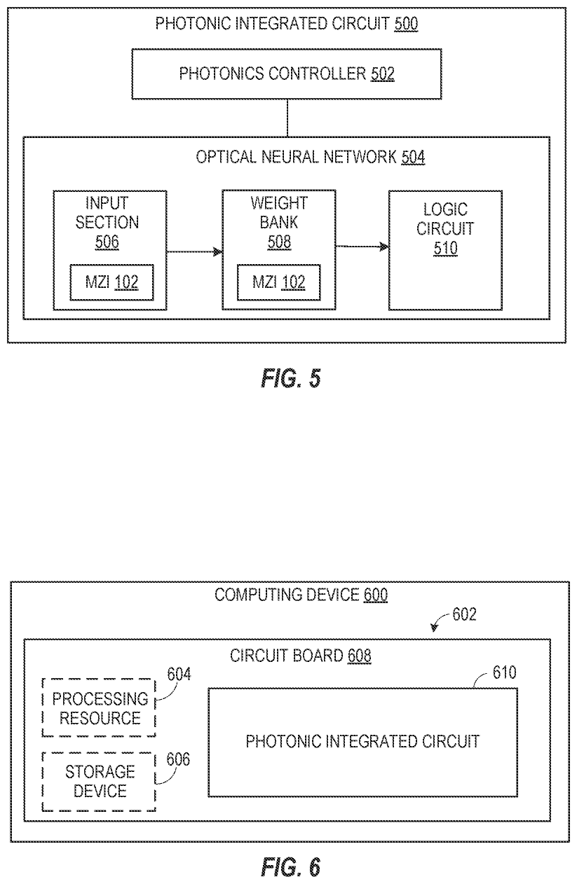

Referring now to FIG. 6, a block diagram of an example computing system 600 is presented. Examples of the computing system 600 may include computers (stationary or portable), servers, storage systems, wireless access points, network switches, routers, docking stations, printers, or scanners. The computing system 600 may be offered as a stand-alone product or a packaged solution and can be utilized on a one-time full product/solution purchase or pay-per-use basis. The computing system 600 may include one or more multi-chip modules, for example, a multi-chip module (MCM) 602 to process and/or store data. In some examples, the MCM 602 may include a processing resource 604 and a storage device 606 mounted on a circuit board 608. Additionally or alternatively to the processing resource 604 and a storage device 606, the MCM 602 may host a photonic integrated circuit 610 on the circuit board 608. In some other examples, one or more of the processing resource 604, the storage device 606, and the photonic integrated circuit 610 may be hosted on separate MCM (not shown). The circuit board 608 may be a printed circuit board (PCB) that includes several electrically conductive traces (not shown) to interconnect the processing resource 604, the storage device 606, and the photonic integrated circuit 610 with each other and/or with other components disposed on or outside of the PCB. The photonic integrated circuit 610 may be an example representative of the photonic integrated circuit 500 of FIG. 5 which may include the MZI 102.

The processing resource 604 may be a physical device, for example, one or more central processing units (CPUs), one or more semiconductor-based microprocessors, microcontrollers, one or more graphics processing units (GPUs), application-specific integrated circuits (ASICs), a field-programmable gate arrays (FPGAs), other hardware devices, or combinations thereof, capable of retrieving and executing the instructions stored in the storage device 606. The processing resource 604 may fetch, decode, and execute the instructions stored in the storage device 606. As an alternative or in addition to executing the instructions, the processing resource 604 may include at least one integrated circuit (IC), control logic, electronic circuits, or combinations thereof that include a number of electronic components. The storage device 606 may be any electronic, magnetic, optical, or any other physical storage device that contains or stores instructions that are readable and executable by the processing resource 604. Thus, the storage device 606 may be, for example, Random Access Memory (RAM), non-volatile RAM (NVRAM), an Electrically Erasable Programmable Read-Only Memory (EEPROM), a storage device, an optical disc, and the like. In some embodiments, the storage device 606 may be a non-transitory storage device, where the term “non-transitory” does not encompass transitory propagating signals.

The terminology used herein is for the purpose of describing particular examples and is not intended to be limiting. As used herein, the singular forms “a,” “an,” and “the” are intended to include the plural forms as well, unless the context clearly indicates otherwise. The term “another,” as used herein, is defined as at least a second or more. The term “coupled to” as used herein, is defined as connected, whether directly without any intervening elements or indirectly with at least one intervening element, unless indicated otherwise. For example, two elements may be coupled to each other mechanically, electrically, optically, or communicatively linked through a communication channel, pathway, network, or system. Further, the term “and/or” as used herein refers to and encompasses any and all possible combinations of the associated listed items. It will also be understood that, although the terms first, second, third, fourth, etc. may be used herein to describe various elements, these elements should not be limited by these terms, as these terms are only used to distinguish one element from another unless stated otherwise or the context indicates otherwise. As used herein, the term “includes” means includes but not limited to, the term “including” means including but not limited to. The term “based on” means based at least in part on.

While certain implementations have been shown and described above, various changes in form and details may be made. For example, some features and/or functions that have been described in relation to one implementation and/or process may be related to other implementations. In other words, processes, features, components, and/or properties described in relation to one implementation may be useful in other implementations. Furthermore, it should be appreciated that the systems and methods described herein may include various combinations and/or sub-combinations of the components and/or features of the different implementations described. Moreover, method blocks described in various methods may be performed in series, parallel, or a combination thereof. Further, the method blocks may as well be performed in a different order than depicted in flow diagrams.

Further, in the foregoing description, numerous details are set forth to provide an understanding of the subject matter disclosed herein. However, an implementation may be practiced without some or all of these details. Other implementations may include modifications, combinations, and variations from the details discussed above. It is intended that the following claims cover such modifications and variations.

What is claimed is:

1. A Mach-Zehnder interferometer (MZI) comprising:
a first waveguide arm; and
a second waveguide arm coupled to the first waveguide arm via a pair of optical couplers,
wherein at least one of the first waveguide arm and the second waveguide arm comprises:
a plurality of Bragg-grating segments; and
a phase-shifter segment formed between adjacent Bragg-grating segments of the plurality of Bragg-grating segments to induce a predefined phase-shift in an optical signal propagating through respective at least one of the first waveguide arm and the second waveguide arm.

2. The MZI of claim 1, wherein the plurality of Bragg-grating segments is formed along a length of at least one of the first waveguide arm and the second waveguide arm.

3. The MZI of claim 1, wherein each of the plurality of Bragg-grating segments comprises a plurality of parallel ridges.

4. The MZI of claim 3, wherein a spacing between adjacent ridges of the plurality of parallel ridges is uniform.

5. The MZI of claim 1, wherein the phase-shifter segment is designed with a predetermined length to induce the predefined phase-shift of IT.

6. The MZI of claim 1, wherein the plurality of Bragg-grating segments and the phase-shifter segment are selectively formed to achieve a standard error of less than 0.02 in transmission compared to a linear response, resulting in a bit-precision improvement of 1 bit compared to a conventional MZI.

7. The MZI of claim 1, wherein at least one of the first waveguide arm and the second waveguide arm further defines a waveguide-integrated capacitor, wherein the plurality of Bragg-grating segments causes a slow light effect and causes an optical mode to align substantially in a middle of the waveguide-integrated capacitor thereby resulting in an enhanced modulation efficiency via the waveguide-integrated capacitor.

8. The MZI of claim 1, wherein the predefined phase-shift induced via the phase-shifter segment increases linearity in an optical output of the MZI increasing a bit-precision of the MZI.

9. The MZI of claim 1, wherein the MZI is disposed in an optical neural network.

10. The MZI of claim 9, wherein the optical neural network is disposed in one or more of a server, a storage device, a router, a network switch, or an access point.

11. A photonic integrated circuit, comprising:
an optical neural network comprising a weight bank, the weight bank comprises a first MZI, wherein the first MZI comprises:
a first waveguide arm; and
a second waveguide arm coupled to the first waveguide arm via a pair of optical couplers,
wherein at least one of the first waveguide arm and the second waveguide arm comprises:
a plurality of Bragg-grating segments; and
a phase-shifter segment formed between adjacent Bragg-grating segments of the plurality of Bragg-grating segments to induce a predefined phase-shift in an optical signal propagating through respective at least one of the first waveguide arm and the second waveguide arm.

12. The photonic integrated circuit of claim 11, wherein the plurality of Bragg-grating segments is formed along a length of at least one of the first waveguide arm and the second waveguide arm.

13. The photonic integrated circuit of claim 11, wherein each of the plurality of Bragg-grating segments comprises a plurality of parallel ridges, wherein a spacing between adjacent ridges of the plurality of parallel ridges is uniform.

14. The photonic integrated circuit of claim 11, wherein a length of the phase-shifter segment is selected to induce the predefined phase-shift of IT increasing linearity of an optical output of the first MZI causing a bit precision of the first MZI to increase.

15. The photonic integrated circuit of claim 11, wherein at least one of the first waveguide arm and the second waveguide arm further defines a waveguide-integrated capacitor, wherein the plurality of Bragg-grating segments causes a slow light effect and causes an optical mode to align substantially in a middle of the waveguide-integrated capacitor thereby resulting in an enhanced modulation efficiency via the waveguide-integrated capacitor.

16. The photonic integrated circuit of claim 11, wherein the optical neural network further comprises an input section receiving optical signals, wherein the input section comprises a second MZI similar to the first MZI.

17. A computing system comprising:
a photonic integrated circuit comprising an optical neural network, wherein the optical neural network comprises an input section and a weight bank coupled to the input section, wherein one or both of the input section and the weight bank comprises an MZI, wherein the MZI comprises:
a first waveguide arm; and
a second waveguide arm coupled to the first waveguide arm via a pair of optical couplers,
wherein at least one of the first waveguide arm and the second waveguide arm comprises:
a plurality of Bragg-grating segments; and
a phase-shifter segment formed between adjacent Bragg-grating segments of the plurality of Bragg-grating segments to induce a predefined phase-shift in an optical signal propagating through respective at least one of the first waveguide arm and the second waveguide arm.

18. The computing system of claim 17, wherein a length of the phase-shifter segment is selected to induce the predefined phase-shift of IT increasing linearity of an optical output of the MZI causing a bit precision of the MZI to increase.

19. The computing system of claim 17, wherein at least one of the first waveguide arm and the second waveguide arm further defines a waveguide-integrated capacitor, wherein the plurality of Bragg-grating segments causes a slow light effect and causes an optical mode to align substantially in a middle of the waveguide-integrated capacitor thereby resulting in an enhanced modulation efficiency via the waveguide-integrated capacitor.

20. The computing system of claim 17, wherein the phase-shifter segment and the plurality of Bragg-grating segments are formed such that a ratio of a length of the phase-shifter segment to a length of a single Bragg-grating segment is 0.08.
